(19) United States
(12) Patent Application Publication
(10) Pub. No.: US 2014/0274207 A1
(43) Pub. Date: Sep. 18, 2014

(54) DATA TRANSFER DEVICE FOR MOBILE TERMINAL

(71) Applicant: Sheng-Yuan SHIH, Taipei City (TW)

(72) Inventor: Sheng-Yuan SHIH, Taipei City (TW)

(21) Appl. No.: 13/804,127

(22) Filed: Mar. 14, 2013

(51) Int. Cl. H04M 1/02

(52) U.S. Cl. CPC H04M 1/0274
USPC 455/557

(57) ABSTRACT

A data transfer device for a mobile terminal, comprising a control unit, a program storage unit, a data storage unit, a power supply unit, a display unit, and a plurality of connection interfaces. When a user electrically connects two mobile terminal using different operating systems with the connection interface of the device, the control unit of the device is activated to execute a control program stored in a program storage unit of the device. The control program is configured to detect different operating systems of the two mobile terminals, and then back up and transfer the data to a metafile, wherein the metafile is backed up in the data storage unit. Then, the metafile is transferred and copied in the target mobile terminal by the control program to finish the data transfer between the two mobile terminals using the different operating systems.

### BACKGROUND OF THE INVENTION

a) Field of the Invention

The present invention relates to a data transfer device for a mobile terminal, and in particular to a device for transferring data between two mobile terminals using the different operating systems.

b) Description of Prior Art

Since a Smartphone becomes popular and versatile, more and more users like web-surfing, taking pictures, listening music, watching videos and sharing information via the Smartphone. Although the Smartphone significantly increases the convenience in our daily life, protecting the data privacy of the user becomes an important issue as more data is stored in the Smartphone.

The current operating systems of the smart phone can be divided into a plurality of categories: iOS (iPhone OS) developed by Apple Inc., Android system developed by Google, Mango system developed by Microsoft, Black Berry system developed by RIM and Symbian system developed by Nokia. Since the data stored in the multi-operating systems system cannot be used in common, as a result dedicated application programs need to be developed respectively for these different operating systems.

Since Smartphone almost becomes the main current in today's market, therefore, a new wave of mobile terminal replacement will be appeared in the future. There are two types of the replacement as the followings:

A cell phone (Non-Smartphone/feature phone) replaces to a smart phone.

A smart phone (Non-Smartphone/feature phone) replaces to another smart phone.

In the first type, since the cell phone is not a smart phone, a user need to key each data into the smart phone if the user wants to transfer the data of the cell phone to the smart phone. Or the user can transfer the data of the cell phone to metafile through a PC (Personal Computer), then store to the smart phone to identify the format of the data. It will make the data transfer inconvenient and waste time for the user.

In the second type, since the operating systems using smart phones are different, the data of the smart phone cannot use in common if the user replaces the different operating system of the smart phone, it will make the inconvenient for the user.

Therefore, the problem solving is using a data transfer device between the different the mobile terminals with different operating systems.

### SUMMARY OF THE INVENTION

An objective of the present invention is to provide a data transfer device for two smart phone using different operation systems.

In order to achieve the above objective, the present invention provides a data transfer device for a mobile terminal, which includes: a control unit, a program storage unit, a data storage unit, a power supply unit, a display unit, and a plurality of connection interfaces. The mobile terminal is configured as a cell phone or a smart phone.

When the data transfer device of the present invention is used to transfer the backup data between two smart phones, the smart phone waiting the data (as a new smart phone) is electrically connected to the data transfer device via the dedicated interface. The other smart phone is electrically connected to the data transfer device via the connection interface and configured to transfer out the data. In the same time, the control program stored in the program storage unit for detects different operating systems of the two smart phones, and then backup both smartphone one by one and each backup data can be further transferring the data to a metafile set. The metafile set is also stored in the data storage unit, and the format of the metafiles can be sqlite, csv, or even txt. The display unit is configured to display the completing status when the data backup is completed and transmit a signal into the smart phone waiting the data transfer. At this time, the smart phone waiting the data transfer is displayed a transfer instruction via a display screen of the smart phone. If a user agrees to transfer the data, the metafile is transferred and restored into the target smart phone by the control program and thus finishing the data transfer between the two smart phones using the different operating systems. The power supply unit is configured to supply necessary electricity to the data transfer device.

Furthermore, the present invention can be also using a process of the data transfer directly. The process is used the shell script to the corresponding database (sqlite) of the individual operation system, for example, contact person, sms message, calendar database and so on, to input each data as record by record into a target mobile-phone database by excuting predefined shell script to achieve the objective of transferring the data between different smartphone OSs.

Another objective of the present invention is to provide a data transfer device for transferring a cell phone and a smart phone.

In order to achieve the above objective, the basic construction of the data transfer device of the present embodiment is substantially the same as that in the previous embodiment, so that the redundant description is omitted for clarity. Only the difference is the data transfer device using for the cell phone and the smart phone.

The advantage of the present invention is to provide the data transfer device for a cell phone and a smart phone or two smart phones using the different operating systems.

### BRIEF DESCRIPTION OF THE DRAWINGS

FIG. 1 is a block view showing the construction of the present invention;

FIG. 2 is a flow chart showing the procedure of a transfer mode between two smart phones of the present invention;

FIG. 3 is a flow chart showing the procedure of a transfer mode between a cell and a smart phone of the present invention;

FIG. 4 is a block view showing the function of the control program of the present invention;

FIG. 5 is a block view showing the three dimensional structure of the present invention.

### DETAILED DESCRIPTION OF THE INVENTION

Please refer to FIG. 1, which is a block view showing the construction of the present invention. The present invention provides a data transfer device for a mobile terminal, which includes a control unit 1, a program storage unit 2, a connection interface 3, a data storage unit 4, a power supply unit 5, a control switch 6, a display unit 7, a dedicated interface 8. The mobile terminal is configured as a cell phone or a smart phone.

The control unit 1 is configured as a processing core of the data transfer device of the present invention and provides signal communications among the respective units. The control unit 1 may be configured as a microprocessor like a central processing unit (CPU), a micro-controller (Micron), a digital signal processor (DSP), an application-specific integrated circuit (ASIC), or a programmable logic circuit (PLD, CPLD, FPGA). The most common control unit 1 is a microprocessor (CPU). The control unit 1 is configured to generate a simplex or multiplex operation.

The program storage unit 2 is configured to store a control program (basic communication protocol used as USB Multiplex Daemon (USBMUXD), adb or other protocol) for detecting an operating system of a mobile terminal, backing up the data and transferring the backup data. The program storage unit 2 may be executed in the Windows or Linux System. The program storage unit 2 receives instructions from the control unit 1 and operates based on the instructions of the control unit 1. The program storage unit 2 is constituted of commands or program codes. The program storage unit 2 may be configured as a flash memory or an electrically-erasable programmable read-only memory (EEPROM, ROM).

The connection interface 3 is electrically connected to the control unit 1 for receiving the signals from the control unit 1. The connection interface 3 is used as a communication interface between the data transfer device of the present invention and the mobile terminal. The connection interface 3 is configured as an electrical connector such as a Micro USB (Universal Serial Bus) or a Mini USB.

The data storage unit 4 is electrically connected to the control unit 1 and the display unit 7. The data storage unit 4 is configured to receive the instructions from the control unit 1 to store digital data. The data storage unit 4 may be configured as a hard disk or a solid state disk.

The power supply unit 5 is configured to provide the necessary electricity to the data transfer device of the present invention and is electrically connected to the control unit 1. The power supply unit 5 may be configured as a built-in battery or an internal power source.

The control switch 6 is electrically connected to the power supply unit 5. The user turns on or off the data transfer device of the present invention via the control switch 6. The control switch 6 may be configured as a DIP switch or a button switch.

The display unit 7 is electrically connected to the control unit 1 for receiving the signals from the control unit 1 and displaying the operating state of the data transfer device of the present invention. The display unit 7 may be configured as a LED (Light Emitting Diode) panel or a liquid crystal display (LCD). The operating state of the data backup device of the present invention is displayed by the display unit 7.

The dedicated interface 8 is electrically connected to the control unit 1 and configured to receive the instructions from the control unit 1. The dedicated interface 8 is used as is a communication interface between the data transfer device of the present invention and a smart phone. The smart phone is waiting a data transfer. The dedicated interface 8 is configured as an electrical connector such as a Micro USB or a Mini USB.

Please refer to FIG. 2, which is a flow chart showing the procedure of a transfer mode between two smart phones of the present invention. The smart phone waiting the data (as a new smart phone in the embodiment) is electrically connected to the data transfer device of the present invention via the dedicated interface. Another smart phone is electrically connected to the data transfer device of the present invention via the connection interface and configured to transfer the data. In the same time, the control program is stored in the program storage unit for detecting different operating systems of the two smart phones, and then backing up and transferring the data to a metafile. The metafile is backed up in the data storage unit. The format of the metafile is configured as Sqlite, csv, or txt. The display unit is configured to display the completing status when the data backup is completed and transmit a signal into the smart phone waiting the data transfer. At this time, the smart phone waiting the data transfer is displayed a transfer instruction via a display screen of the smart phone. If a user agrees to transfer the data, the metafile is transferred and restored into the smart phone by the control program to finish the data transfer between the two smart phones using the different operating systems.

Furthermore, the present invention is also using a process of the data transfer directly. The process is used the shell script to the corresponding database (SQlite) of the individual operation system, for example, contact person, short message, calendar and so on, to input each data as record by record into a target mobile-phone database by executing shell script/program to achieve the objection of transferring the data.

Please refer to FIG. 3, which is a flow chart showing the procedure of a transfer mode between a cell and a smart phone of the present invention. The smart phone waiting the data transfer (as a new smart phone in the embodiment) is electrically connected to the data transfer device of the present invention via the dedicated interface. The cell phone is electrically connected to the data transfer device of the present invention via the connection interface and configured to transfer the data. In the same time, the control program is stored in the program storage unit for detecting different operating systems of the phones and transferring the data to a metafile. The metafile is backed up in the data storage unit. The format of the metafile is configured as Sqlite, csv, or txt. The display unit is configured to display the completing status when the data backup is completed and transmit a signal into the smart phone waiting the data transfer. At this time, the smart phone waiting the data transfer is displayed a transfer instruction via a display screen of the smart phone. If a user agrees to transfer the data, the metafile is copied in the smart phone by the control program to finish the data transfer between the two phones.

Please refer to FIG. 4, which is a block view showing the function of the control program of the present invention. The control program comprises a unit 211 for detecting system and fetching data (including mobile terminal communication protocol) of the cell phone, an interactive unit 212, and a unit 213 for detecting system and fetching data (including mobile terminal communication protocol) of the smart phone. The control program 21 is configured to detect the operating system and data of the cell phone and the data can be transmitted into the smart phone via the interaction unit 212. The control programs 21 also can be used to detect the different operation systems between the two smart phones and transmit the data into one of the smart phones to finish data transfer.

Please refer to FIG. 5, which is a block view showing the three dimensional structure of the present invention. The data transfer device of the invention comprises a body 9. The control unit 7, the program storage unit 2, the data storage unit 4 and the power supply unit 5 are disposed inner of the body 9. The display unit 7, connection interface 3, dedicated interface 8 and control switch 6 are disposed outer of the body 9. The connection interface 3 and dedicated interface 8 are configured to connect the different mobile terminal. The control switch 6 is configured to control the power supply status.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A data transfer device for a mobile terminal, including:
a control unit, configured as an operation micro-processor for providing signal communication between respective units;
a program storage unit, configured as a memory connected to the control unit, the program storage unit being configured to store a control program, the control program detecting system of the mobile terminal and transferring data of the mobile terminal to a metafile and receiving instructions from the control unit;
a plurality of connection interfaces, configured as a connector for receiving a signal from the control unit and transmitting a signal from the mobile terminal into the control unit;
a data storage unit, configured to receive the instructions from the control unit and store digital data;
a power supply unit, electrically connected to the control unit for providing electricity; and
a display unit, configured to receive the signal from the control unit and display an operating state of the device.

2. The data transfer device according to claim 1, wherein the power supply unit is electrically connected to a control switch, the user can turn on or off the data transfer device via the control switch.

3. The data transfer device according to claim 1, wherein the control program comprises a unit for detecting system and fetching data of the mobile terminal, an interactive unit and a unit for detecting system and fetching data of the other mobile terminal, each unit is electrically connected to receive signal from each other; the control program is configured to detect an operating system and data of the mobile terminal and transmit the data into the other mobile terminal via the interaction unit.

4. The data transfer device according to claim 1, wherein the control unit is configured as a central processing unit, a micro-controller, a digital signal processor, an application-specific integrated circuit, or a programmable logic circuit.

5. The data transfer device according to claim 1, wherein the program storage unit is configured as flash memory or an electrically-erasable programmable read-only memory.

6. The data transfer device according to claim 1, wherein the connection interfaces is configured as a Micro USB (Universal Serial Bus) connector or Mini USB connector.

7. The data transfer device according to claim 1, wherein the data storage unit is configured as a hard disk or a solid state disk.

8. The data transfer device according to claim 1, wherein the power supply unit is configured as a built-in battery or an internal power source.

9. The data transfer device according to claim 2, wherein the control switch is configured as a DIP switch or a button switch.

10. The data transfer device according to claim 1, wherein the display unit is configured as a LED (Light Emitting Diode) panel or a liquid crystal display.

11. The data transfer device according to claim 1, wherein the program of the program storage unit is configured to store and execute in the Windows or Linux System.

12. The data transfer device according to claim 1, wherein the program of the program storage unit is constituted of commands or program codes.

13. The data transfer device according to claim 1, wherein the format of the metafile is configured as Sqlite, csv, or txt.
